(19) United States
(12) Patent Application Publication
(10) Pub. No.: US 2003/0111862 A1
(43) Pub. Date: Jun. 19, 2003

(54) Door stop for vehicles

(76) Inventor: Vittorio Audisio, Via Monte Pulciano (IT)

Correspondence Address: TRASK BRITT, P.O. BOX 2550, SALT LAKE CITY, UT, 84110, US

(21) Appl. No.: 10/159,943

(22) Filed: May 30, 2002

(30) Foreign Application Priority Data
Dec. 14, 2001 (EP) 01830767.8

(51) Int. Cl. B60J 1/08; B60J 5/00

(52) U.S. Cl. 296/146.1; 296/202; 296/146.11

(57) ABSTRACT

Door stop for motor vehicles comprising:

a base structure (12) made of pressed steel sheet with two parallel sides (14, 16),

a first roller (26) rotationally mounted on a pin (30) extending through two holes (50, 52) aligned in said parallel sides (14, 16),

an elastic element (32), having a first end (34) anchored to the base structure (12) and carrying at a second end a second roller (28), whose axis is parallel to the axis of the first roller (26),

a tie-rod (42), having two opposite rolling surfaces (44, 46) on which said rollers (26, 28) are pressed by the force of said elastic element (32), and

at least one plastic material bushing (62) arranged in between the pin (30) and at least one of said holes (50, 52).

The invention relates to a door stop for motor vehicles, of the type comprising:

a base structure made of bent steel sheet with two parallel sides,

a first roller rotationally mounted on a pin extending through two holes aligned in said parallel sides,

an elongated elastic element having a first end anchored to the base structure and carrying at a second end a second roller, whose axis is parallel to the axis of the first roller, and

a tie-rod having two opposite rolling surfaces on which said rollers are pressed by the force of said elastic element.

Door stops of this type are used to withhold the doors of motor vehicles in intermediate or fully open positions. In use, the base structure of the door stop is generally fastened to the door and one end of the tie-rod is jointed to a pillar of the vehicle, so that the opening and closing movements of the door generate a relative movement between the tie-rod and the rollers. Positioning notches are usually formed on the rolling surface of the tie-rod. The notches are engaged by the rollers to define stabile retaining positions corresponding, for example, to the partially or fully open positions of the door.

The technical problem on which this invention is based concerns the noise generated by the door stop devices of this type during the opening and closing movement of the door. In the past, the Applicant proposed and implemented various arrangements and improvements which considerably reduced the noise of door stops of the type specified above. Recent studies and researches conducted by the Applicant have demonstrated that, despite the various arrangements successfully adopted to this time to reduce noise, an additional source of noise exists related to the elastic deformation of the base structure produced by the sliding movement of the tie-rod between the rollers.

The object of the invention is to provide a simple, low-cost solution for eliminating this additional source of noise.

According to the invention, this object is achieved thanks to a door stop having the characteristics recited in the main claim.

Additional characteristics and advantages of the invention will now be described, by way of example only, with reference to the accompanying drawings wherein:

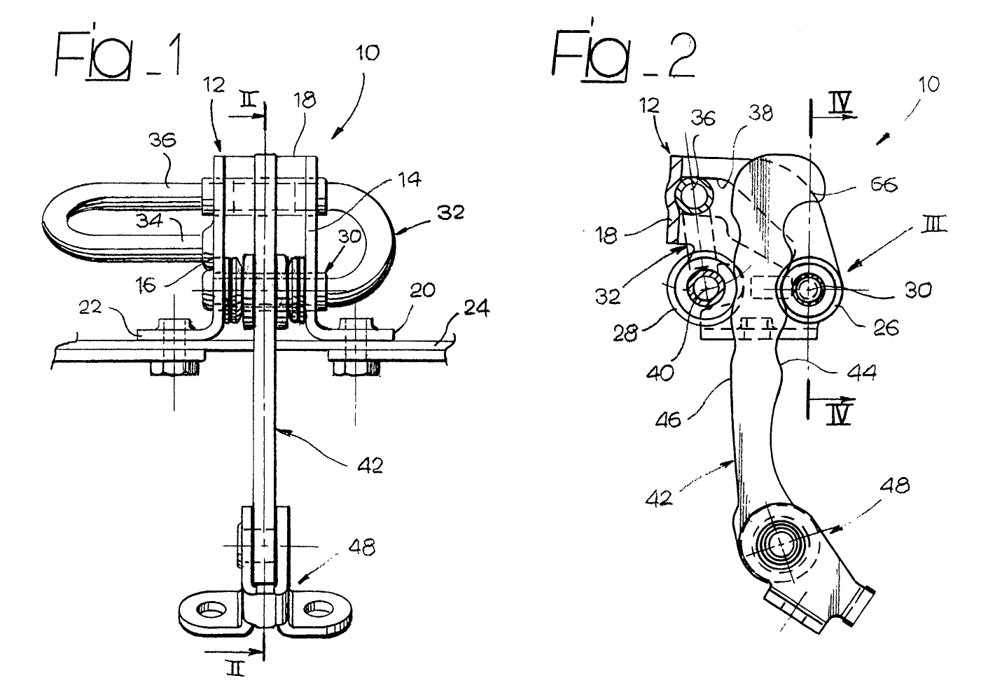

FIG. 1 is a plan view of a door stop according to the invention,

FIG. 2 is a cross-sectional view according to the line II-II in FIG. 1,

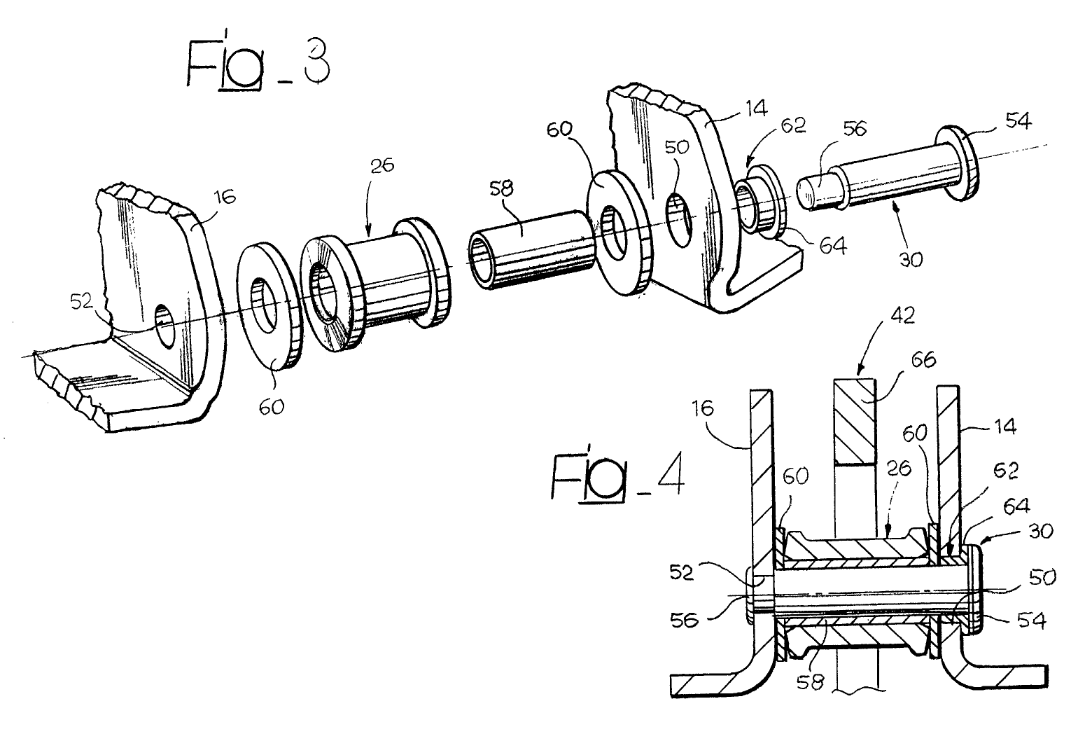

FIG. 3 is a perspective exploded view of the detail indicated by the arrow II in FIG. 2, and

FIG. 4 is a cross-sectional view according to the line IV-IV in FIG. 2.

With reference to FIGS. 1 and 2, numeral 10 indicates a door stop for motor vehicle doors. The device 10 comprises a base structure 21 made of pressed steel sheet with two parallel sides 14, 16 reciprocally jointed by a bottom side 18. The parallel sides 14, 16 have respective tabs 20, 22 with holes for fastening the base structure 12 to the structure of a motor vehicle door, generically indicated with numeral 24 in FIG. 1. Two rollers 26, 28, whose axes are reciprocally parallel, are arranged in the space between the two sides 14, 16. The first roller is rotationally mounted on a pin 30 fastened to base structure 12 as described below. The second roller 28 is rotationally mounted on one end of an elastic element 32 consisting of a metallic bar with a circular cross-section, generally shaped as an “S”. According to prior art, one end 34 of the elastic element 32 is anchored to the base structure 12, the central straight section 36 of the elastic element 32 extends through openings 38 in the parallel sides 14, 16 and the second roller 28 is rotationally mounted on a second end 40 of the elastic element 32.

A metallic tie-rod 42 is mobile between the rollers 26, 28. The tie-rod 42 has two opposite rolling surfaces 44, 46 on which the rollers 26, 28 are pressed by the force generated by the elastic elements 32. The tie-rod 42 is equipped with a plurality of positioning notches on the rolling surface 44, 46 which co-operate with the rollers 26, 28 to define, for example, two positions in which the door is partially open and one position in which the door is fully open. One end of the tie-rod 42 is jointed to a bracket 48 which is intended to be fastened to the pillar of the motor vehicle (not shown).

With reference to FIGS. 3 and 4, the parallel sides 14, 16 of the base structure 12 are equipped with respective co-axial holes 50, 52. The pin 30 has a head 54 and a spacer end 56 which is riveted after insertion in hole 52. FIG. 4 illustrates the end 56 of the pin 30 after riveting. The roller 26 is mounted on the pin 30 by intermediate arrangement of a bushing 58. Preferably, a washer 60 is arranged between each front end of the roller 26 and the respective side 16.

According to the invention, a plastic material bushing 62 is arranged between the surface of the hole 50 and the corresponding portion of the external surface of the pin 30. The bushing 62 is preferably equipped with a radial flange 64 between the head 54 of the pin 30 and the external surface of the side 14.

In traditional solutions, the pin 30 was directly in contact with the inner surfaces of the hole 50. Studies conducted by the Applicant have shown that one of the causes of noise in the door stops according to prior art was related to the metal of the surface of the hole 50 sliding on the metal of the external surface of the pin 30 caused by the elastic deformation of the sides 14, 16 when the tie-rod 42 slides between the rollers 26, 28 and, particularly, when the tie-rod 42 reaches its end-of-travel position, in which the hook shaped end 66 of the tie-rod 42 transmits a considerable amount of energy to the base structure 12 after knocking against the roller 26.

The presence of a plastic material bushing 62 between the hole 50 and the pin 30 solves the problem of this type of noise, avoiding the direct contact between the pin and the side 14. There are no problems of movement in the area of contact between the end 56 of the pin 30 and the side 16 because the pin is solidly fastened to the side 16 by the riveted portion 56. A bushing 62 may be arranged in correspondence to the hole 52 only if the pin 30 is fastened to the side 16 by means of a connection system which provides a possibility of relative movement between the pin and the hole 52 by effect of the elastic deformation of the side 16. The bushing 62 is preferably made of acetal plastic material. The bushing can be either a separate component or formed by a layer of plastic material co-moulded on the external surface of the pin 30. Preferably, the bushing 62 is a cylindrical part whose length is approximately equal to the thickness of the side 14 so that in the assembled condition, illustrated in FIG. 4, the bushing 62 does not interfere with the washer 60.

1. Door stop for motor vehicles comprising:
a base structure made of pressed steel sheet with two parallel sides,
a first roller rotationally mounted on a pin extending through two holes aligned in said parallel sides,
an elastic element, having a first end anchored to the base structure and carrying at a second end a second roller, whose axis is parallel to the axis of the first roller,
a tie-rod, having two opposite rolling surfaces on which said rollers are pressed by the force of said elastic element, and
at least one plastic material bushing arranged in between the pin and at least one of said holes.

2. Door stop according to claim 1, wherein said pin comprises a head facing one of said sides and a riveted portion fastened to a second of said sides in which a single bushing is arranged near the head of the pin.

3. Door stop according to claim 2, wherein said bushing has a radial flange arranged between the head of the pin and an external surface of the corresponding side.

4. Door stop according to claim 3, wherein said bushing has a cylindrical portion whose length is substantially equal to the thickness of the corresponding side.

5. Door stop according to claim 1, wherein said bushing is made of acetal plastic material.

6. Door stop according to claim 1, wherein said bushing consists of a layer of plastic material co-moulded on the pin.

7. Door stop according to claim 1, wherein said bushing is separate from the pin.
